(19) United States
(12) Patent Application Publication
(10) Pub. No.: US 2025/0122112 A1
(43) Pub. Date: Apr. 17, 2025

(54) HIGH SALINITY PRODUCED WATER DESALINATION

(71) Applicant: Clean H2O Technologies, LLC, Houston, TX (US)

(72) Inventors: Ramesh Sharma, Houston, TX (US); Lisa Henthorne, Houston, TX (US); Austin Beam, Houston, TX (US)

(73) Assignee: Clean H2O Technologies, LLC, Houston, TX (US)

(21) Appl. No.: 18/913,503

(22) Filed: Oct. 11, 2024

Related U.S. Application Data
(60) Provisional application No. 63/543,991, filed on Oct. 13, 2023.

(51) Int. Cl. C02F 9/00; C02F 1/04; C02F 1/20; C02F 1/44; C02F 1/66; C02F 101/10; C02F 101/32; C02F 103/10

(52) U.S. Cl. CPC C02F 9/00; C02F 1/04; C02F 1/20; C02F 1/441; C02F 1/66; C02F 2101/10; C02F 2101/32; C02F 2103/10

(57) ABSTRACT

Desalination of produced water is performed by pre-treatment of produced water to reduce pH, whereupon the reduced pH produced water is fed into desalination unit thereby producing high-quality desalinated water and also increasing the longevity of desalination unit by not clogging filters of the desalination unit. The method can be coupled with any desalination unit on site, thus allowing flexibility in application.

### FIELD OF THE INVENTION

The present invention generally relates to methods, and desalination units employing methods, for generating high-quality desalinated water from produced water in an oil production facility. More specifically, for example, the pH of produced water is lowered prior to desalination by membrane or thermal desalination methods thereby ensuring no precipitation of salts or other inorganic matter occur prior to desalination and facilitating smooth operation of desalination, without significant precipitation of calcium and magnesium carbonate.

### BACKGROUND

Produced water (PW) is water that comes out of the well with crude oil during crude oil production. Produced water can contain water naturally present in the rock, water injected into the reservoir in steam-based operations, and water from fracking operations. It also includes soluble and insoluble oil and organics, dissolved solids, and salts, and may include one or more of various other elements, chemicals, and materials used in the oil well completion or production process or which is a byproduct of such process(es). The composition of produced water will vary based on, among other things, geography, age of the oil well, chemicals used during hydraulic fracturing and production. Table 1 provides an example of a typical composition of produced water. High total dissolved solids (TDS) and high hardness with low bicarbonate is a common signature of many produced waters.

TABLE 1
Composition of oilfield produced water

| | | | | Mini- | Maxi- |
|---|---|---|---|---|---|
| | Mini- | Maxi- | | mum | mum |
| | mum | mum | Major | value | value |
| Parameter | value | value | ions | (mg/l) | (mg/1) |
| Density (kg/m³) | 1014 | 1140 | Calcium | 13 | 25 800 |
| Conductivity | 4200 | 58 600 | Sodium | 132 | 97 000 |
| (μS/cm) | | | | | |
| Surface tension | 43 | 78 | Potassium | 24 | 4300 |
| (dyn/cm) | | | | | |
| pH | 4.3 | 10 | Magnesium | 8 | 6000 |
| TOC (mg/l) | 0 | 1500 | Iron | <0.1 | 100 |
| TSS (mg/l) | 1.2 | 1000 | Aluminium | 310 | 410 |
| Total oil (IR; mg/l) | 2 | 565 | Boron | 5 | 95 |
| Volatile (BTX; mg/1) | 0.39 | 35 | Barium | 1.3 | 650 |
| Base/neutrals (mg/l) | — | <140 | Cadmium | <0.005 | 0.2 |
| Chloride (mg/l) | 80 | 200 000 | Copper | <0.02 | 1.5 |
| Bicarbonate (mg/1) | 77 | 3990 | Chromium | 0.02 | 1.1 |
| Sulphate (mg/l) | <2 | 1650 | Lithium | 3 | 50 |
| Ammoniacal | 10 | 300 | Manganese | <0.004 | 175 |
| nitrogen (mg/l) | | | | | |
| Sulphite (mg/1) | — | 10 | Lead | 0.002 | 8.8 |
| Total polar (mg/L) | 9.7 | 600 | Strontium | 0.02 | 1000 |
| Higher acids (mg/l) | <1 | 63 | Titanium | <0.01 | 0.7 |
| Phenol (mg/l) | 0.009 | 23 | Zinc | 0.01 | 35 |
| Volatile fatty acids | 2 | 4900 | Arsenic | <0.005 | 0.3 |
| (mg/l) | | | | | |
| | | | Mercury | <0.005 | 0.3 |
| | | | Silver | <0.001 | 0.15 |
| | | | Beryllium | <0.001 | 0.004 |

Significant volumes of produced water may be produced for every barrel of oil produced. As an example, ˜75,000 m³ to 135,000 m³ (˜475,000 to 850,000 bbl) of water is required to develop one well drilled 2,400 m (7,875 ft) deep, in a typical unconventional shale oil and gas development. A typical mid-size to large shale production facility has about 10-15 wells. Nearly 50% of the water is returned, or flows back, to the surface. Formation water contained within the geology of the producing formation will also be co-produced with the oil. In the Permian Basin, for instance, between 2-9 barrels of water per barrel of oil flows to the surface, requiring treatment, recycling and/or disposal. Reuse of produced water in completions (subsequent hydraulic fracturing operations) can consume a portion of this water but significant more is produced than is needed. Beneficial reuse, as an alternative to deep well disposal, of treated produced water in applications other than completions activities is therefore an important component of future disposal options.

Before produced water can be reused, however, it must be treated to remove oil and grease, heavy metals, dissolved salts and chemicals, suspended solids, etc. The type of treatment and the rigor involved depends on the location of produced water and is also heavily dependent on the end-use for the produced water. When reusing for hydraulic fracturing operations, the level of treatment required is less, compared to reusing for other beneficial purposes such as irrigation or groundwater recharge or many industrial uses. The more treatment required, the more expensive the process.

After treatment of the produced water to remove all suspended impurities, utilizing the water for purposes outside of oil and gas usually requires the capital-intensive step of desalination. Salinity of produced water ranges from nearly fresh (<1%) to about 40% salt content. As a comparative example, sea water only has a salinity of about 3.5%. The composition and salinity of produced water is influenced by several factors, chief among them is the geographical location of the facility. Salinity of produced water is expressed as total dissolved solids (TDS). Depending on the geographic location of the oil and gas facility, the TDS of the produced water varies from as low as 200 mg/L to as high as 400,000 mg/L. Following desalination, produced water must be further treated to remove any trace organic or inorganic impurities, and be re-mineralized to be stable in the environment.

Conventional desalination methods for water treatment include membrane desalination, like reverse osmosis (RO), nanofiltration, and electrolysis. Other methods include thermal distillation systems, multiple-effect distillation, multiple-stage distillation, vapor condensation, and falling-film evaporation.

In a simple RO system, desalinated water is pushed through a semipermeable membrane that limits passage of dissolved chemicals and salts. Thus, dissolved salts, colloidal and suspended solids and matter can be removed from contaminated water. Although RO is a commonly used method, it suffers from the disadvantage that the membrane used for RO often experiences fouling and thus may be associated with high maintenance cost.

The pH of produced water after pre-treatment to remove oil and grease, chemicals, and minerals, prior to feeding into membrane (e.g., RO) or thermal desalination unit is typically in the range 6-9. Basic salts such as carbonate and bicarbonate are typically found in the produced water, along with very high levels of hardness-forming ions such as calcium and magnesium. When fed into a desalination unit (to perform, for example, RO or thermal desalination), salts may precipitate out of solution when they reach their solubility limit, thus clogging up the desalination unit. Repeated scaling and membrane blockages by salts impact the operational efficiency of the desalination process and cause frequent cleaning, making the process more expensive and inefficient. Depending on the pH, dissolved ammonia may pass into the desalinated water and the resulting water contains high concentrations of ammonia, thereby requiring additional treatment prior to its use in most applications.

Thus, what is needed in the art are efficient and more cost-effective methods for desalination of produced water to produce water of high quality. The ideal method would be cost effective, have a low footprint, and provide a means to eliminate or significantly reduce the concentration of salts in the produced water. Consequently, the method would yield produced water of very high quality suitable for consumption and agricultural purposes. Such a method would also not harm the equipment at the production facility and would be easy to install, operate, reliable, and have high efficiency. The present invention addresses one or more of these needs.

Conventional methods for removing scaling salts that increase the risk in high salinity desalination processes require addition of large quantities of lime and soda ash to raise the pH, thereby precipitating CaCO₃ and Mg(OH)₂. These precipitates require sludge disposal, requiring transportation and landfilling. Due to the high calcium and magnesium concentrations in typical high salinity produced water, this conventional or excess lime softening method results in excessive operating costs due to both chemical addition and sludge disposal costs, and adds to the complexity and costs of high salinity produced water desalination. Lime softening is commonly used in brackish water treatment to remove hardness.

### SUMMARY OF THE INVENTION

Described herein are methods, and desalination units, for desalinating produced water to produce water of high quality suitable for re-introducing in ground water stream, consumption, and irrigation. An exemplary method of the present invention involves primary and secondary treatments to de-oil and remove suspended solids and the like. Before desalination, however, the pH of the produced water is reduced to pH 5-6. This converts carbonate to CO₂, which can be stripped out, and reduces the degree of saturation of calcium carbonate and magnesium carbonate. By doing this, the need for capital intensive lime softening can be lessened or eliminated prior to desalination. The remaining calcium and magnesium ions are filtered out in desalination, without the problem of scaling.

Existing desalination units on the production platform or in the field can be fitted with a unit to reduce the pH of water, thus increasing the quality of the cleaned produced water, and increasing the efficiency of the desalination unit. The desalination method and process described herein can also be applied in facilities with limited space and offshore operations.

In one example, produced water is treated to remove volatile and non-volatile organic solutes, contaminants such as fats, oil, grease (FOG), microorganisms, chlorides, sulfides, precipitated polymers, and other frac chemicals with appropriate methods.

This water is then pretreated by acidification prior to desalination. Water is acidified to obtain a pH about 5-6. At this pH, carbonate and bicarbonate species in the water convert to carbon dioxide, as shown in Equations 1a) and 1b) below. The released carbon dioxide is removed from the water via air stripping and can be fed into a carbon dioxide compression compartment and reused in the reservoir or even sequestered therein. The ready water is then desalinated, e.g., with a membrane desalinator or a thermal desalinator, and because the carbonate has been removed from the water, it is not available to precipitate and form scale in the desalination process.

HCO₃⁻(aq)→CO₂(g)+H⁺(aq) Equation 1a.

CO₃²⁻(aq)→CO₂(g) Equation 1b.

Customizable pH adjustment units are commercially available that can be fitted into the produced water purification units. A typical pH adjustment unit for water treatment uses sulfuric acid, phosphoric acid, hydrochloric acid, or nitric acid. The application of the acidizing solution to adjust the pH of treated produced water depends on factors including the concentration of salts dissolved in the water, the pH of the produced water prior to desalination and chemicals in the water.

Sulfuric acid (H2SO4) solution is the most used and least expensive neutralization and acidizing solution for produced water. Concentrations of 25% to 96% in aqueous solution of sulfuric acid are typically used, although concentrations of 35% to 65% are also commercially available. Sulfuric acid is very potent and is generally safer to use than other acids like nitric acid or hydrochloric acid.

Phosphoric acid (H3PO4) is generally safe and inexpensive. It is a weaker acid than sulfuric or hydrochloric acid. The reaction of phosphoric acid to acidify a solution is relatively slower and a higher contact time with the solution is required.

Hydrochloric acid (HCl) is also a commonly used acid for large scale industrial scale reactions. It is inexpensive and effective. HCl has some safety concerns as fumes of HCl gas at higher concentrations can be corrosive and cause damage to the pH adjustment unit. It is usually used at well ventilated facilities or outdoors. However, the reaction with HCl is quick and the pH can be appropriately reduced to the desired pH relatively faster thereby reducing acid contact time. This also eliminates formation of scale-forming sulfate salt (as is the case with H₂ SO₄ addition).

Any commercially available pH adjustment chemical unit can be fitted to a RO unit, or any other membrane or thermal desalination unit used on site. The acid used in the skid would be dependent on the quality of water after the removal of chemicals and other waste. If the produced water has basic impurities including calcium and magnesium carbonates, silicates, fluorides, phosphates, sulfates, nitrates and ferrous compounds, the acid used in the skid would be a strong acid like hydrochloric acid. It is desirable to monitor the pH of the water after treatment and before water enters the desalination unit.

A typical RO filter for industrial membrane desalination and filtration are pressure-driven membranes. RO filters can remove contaminants as small as 0.0001 μm. The efficiency of the RO systems depends on the pre-treatment of the produced water. Although RO membranes are prone to clogging and fouling, with the pre-treatment by reducing pH of the produced water, the lifespan of the RO membrane can be increased by minimizing and eliminating fouling and clogging of the membranes by excess salts. RO membrane systems are applicable for treating water containing TDS in the range of 500-25,000 ppm. A typical industrial RO system has a lifespan of about 3-7 years, but with the pre-treatment by acidification as taught herein, the lifespan of the RO filters can be increased by 3-4 additional years. Importantly, they will provide increased uptime and require less chemical cleaning to remove calcite deposits on the membrane surface.

Industrial RO systems may contain several pre- and post-RO filter parts including multimedia prefilter, water softener or anti-scalant dosing system, dichlorination dosing system, RO unit with semi-permeable membrane and a post chlorination treatment. They may also be fitted with ultraviolet sterilizers. The RO system uses the reverse osmosis technology by transporting feed water through a multimedia prefilter to remove particles larger than a said particle size. Typically, the size is <5 micron. By pre-treatment with pH reducers, fouling of the RO membrane is reduced significantly, and the RO filters can continue to operate without removing and changing out membrane elements. Fresh, potable water is pumped out of the RO system, and collected salts, minerals and other impurities are discharged as brine stream. Optionally, water passes through a UV sterilizer to rid the water of any bacteria and microbes that may have passed through the filters. Note that conventional RO technology is not suitable for treating high salinity produced water, but can be used on waters with TDS levels below 60,000 mg/L. Alternatively, for treating higher salinity produced water, alternative RO membrane technology may be applied including osmotically-assisted RO or high pressure RO.

In another example, the pH adjustment skid is installed before the produced water is fed into a thermal desalination treatment on site. Thermal desalination units are typically larger in size and require more energy to operate, but they can also handle higher salt loads. A thermal desalination unit can be operated for water with TDS levels 500 to about 200,000 ppm. The cleaned water from a thermal desalination unit usually contains about 0.002 to about 0.0014 ppm (10-1000 mg/L) TDS. But with robust pre-treatment with pH adjustments, the final TDS after thermal treatment can be as low as 0-0.1 ppm.

In produced water containing ammonium salts and dissolved ammonia, thermal desalination is a preferred method. If the pH of the produced water is high, ammonia is in a gaseous state and ends up in the distillate. If the pH of the produced water is low, ammonium ions typically remain dissolved in the water.

As used herein, pH, by definition, is the measure of free hydrogen activity in water, thereby assessing how acidic or basic a substance is. pH of 7 is considered neutral, pH 0-7 is acidic and 7-14 is considered basic.

As used herein, “TOC” is total organic carbon, usually in mg/L or ppm.

As used herein, TSS is total suspended solids. These can be removed by settling, with or without coagulants and flocculants, filtration, and the like.

As used herein, TDS is total dissolved solids. It is typically measured in ppm or mg or g/L of salt in water. The TDS of acceptable drinking water is regulated by the EPA and less than 300 mg/L is generally considered excellent drinking water.

As used herein, the “Langelier Saturation Index” (sometimes Langelier stability index) is a calculated number used to predict the calcium carbonate stability of water. It indicates whether the water will precipitate, dissolve, or be in equilibrium with calcium carbonate. Wilfred Langelier developed a method in 1936 for predicting the pH at which water is saturated in calcium carbonate (called pHs). The LSI is expressed as the difference between the actual system pH and the saturation pH:

LSI=pH(measured)−pHs

For LSI>0, water is super saturated and tends to precipitate a scale layer of CaCO₃. For LSI=0, water is saturated (in equilibrium) with CaCO₃. A scale layer of CaCO₃ is neither precipitated nor dissolved. For LSI<0, water is under saturated and tends to dissolve solid CaCO₃.

As used herein, “de-oiling” treatment reduces the small amounts of oil still in the produced water after the oil-and-water separator separates the bulk of emulsion into oil and water (and gas). Methods of de-oiling include hydrocyclones, centrifuges, corrugated plate separators (CPS) or corrugated plate interceptors (CPIs), passive gravity separation, skimming, flotation, carbon filters, nutshell filtration, and combinations thereof.

The oil-and-gas separator typically does not remove all oil and a secondary treatment usually uses chemicals to remove emulsified and the dissolved oil by flotation. Small gas bubbles (nitrogen, air, or fuel gas most common) to attach and float O&G with a bottom solids removal device. These methods may also use chemical (coagulant and/or flocculant) for better removal efficiencies. Methods include induced gas flotation (IGF), dissolved gas flotation (DGF), dissolved air flotation (DAF), dissolved nitrogen flotation (DNF) or a compact flotation unit (CFU) or microbubble flotation.

The conventional method for heavy metal removal from industrial wastewater generally involves a chemical precipitation process. Hydroxide precipitation is the most common treatment technology. Multi-valent ions and heavy metals are removed by adding alkali such as caustic, lime or soda ash to adjust the wastewater pH to the point where the metals exhibit minimum solubility. Then a proper solid-liquid separation technique removes the metal precipitation such as sedimentation and filtration. The conventional heavy metal removal process has some inherent shortcomings such as requiring a large area of land, a sludge dewatering facility, skillful operators and multiple basin configurations.

High silica and hardness are usually managed by the “lime softening process” wherein the addition of limewater (calcium hydroxide) removes hardness (deposits of calcium and magnesium salts) by precipitation. However, the acid removal of carbonates, as taught herein, allow us to omit lime softening, thereby avoiding the costly and environmentally unfriendly process for many produced waters due to the amount of lime and sodium carbonate required and the mass of solids resulting from the softening process that must be hauled and landfilled. Silica is undersaturated as water goes through the desalination, so is not impacted by lowering the pH.

As used herein, “stripping” is a method of stripping dissolved gases from produced water to alleviate scaling and corrosion concerns. Such stripping could be, for example, steam, air, or natural gas stripping. Its purpose is to drive off H₂S, CO₂, and O₂ without vaporizing significant amounts of water. Produced water is first acidified to pH 4.0 using e.g., sulfuric or hydrochloric acid and dissolved gases are removed in the stripping process before feeding into the evaporation unit and heated to its bubble point. The distillate or water vapor generated is condensed and collected. An additional benefit of stripping is that it has the potential to greatly reduce VOC and other gas (e.g., ammonia) concentrations in the product streams, especially in the distillate. It can be thus sometimes used as a pretreatment step before desalination.

As used herein, “ready-water” is water that has been acidified so as convert carbonate to CO₂, reduce the Langelier saturation index, thus being ready to enter the desalination unit without the need for expensive hardness removal pre-treatment step. The gases can be removed or scavenged and used for storage, or even just allowed to collect at the top, and the ready-liquid sent to the desalinator.

As used herein, “desalination” is a method of removing salts from PW. Desalination can utilize either thermal processes (involving heat transfer and a phase change) or membrane processes (using thin sheets of synthetic semipermeable materials to separate water from dissolved salt).

As used herein, “membrane desalination” technologies used for PW desalination, include reverse osmosis (RO), forward osmosis (FO) and membrane distillation (MD).

As used herein, “thermal desalination” uses heat and evaporation to separate water and salts. Technologies include multistage flash (MSF) distillation, multieffect distillation (MED), vapor compression (VC), thermal vapor compression (TVC), falling-film evaporator, and mechanical vapor compression (MVC).

Other desalination processes include solar still distillation, humidification-dehumidification, membrane distillation, and freeze/thaw desalination.

As used herein, “polishing” or “tertiary” treatments are typically a post desalination treatments, used as needed to bring the cleaned PW to code. Polishing methods include various filtration methods, absorbance methods and chemical or biological oxidation methods.

Filtration methods include nutshell or walnut shell filters, various filter media, multimedia filters (MMF), deep bed multi-filtration media, activated carbon filters and ceramic and polymeric Microfiltration (MF) or ultrafiltration (UF).

“Adsorption” is commonly used for the treatment of produced water, as it can remove more than 80 percent of organics and results in nearly 100 percent product water recovery. A variety of materials are used for adsorption, including zeolites, organoclays, activated alumina, and activated carbon, which can remove iron, manganese, TOC, and other contaminants. Chemical use is minimal. However, the adsorbent can be easily overloaded with large concentrations of organics, so this process is not always ideal for primary treatment. The media also eventually become consumed with contaminants and must be disposed or regenerated using chemicals. Regeneration creates a liquid waste product that must be disposed. Media may require frequent replacement or regeneration depending on type and feedwater quality.

Oxidation can be used to remove organics and some inorganic compounds like iron and manganese. Oxidants like chlorine, chlorine dioxide, permanganate, oxygen, and ozone are also frequently used to treat produced water. No pretreatment is required, but solid separation post-treatment is often necessary to remove oxidized particles. Oxidation can sometimes be a more expensive method, as chemical costs may be high and the purchase of chemical metering pumps is required for dosing.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements, but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

| ABBREVIATION | TERM |
|---|---|
| BTX | Benzene, toluene, and xylene |
| CPF | Central Processing Facility |
| FOG | Fats, oil, and grease |
| MED | Multieffect distillation |
| MSF | Multistage flash |
| MVC | Mechanical vapor compression |
| PW | Produced water |
| TDS | Total dissolved solids |
| TOC | Total organic carbon |
| TSS | Total suspended solids |
| UV | Ultra violet |
| VCD | Vapor compression distillation |
| VOC | Volatile organic compounds |

### BRIEF DESCRIPTION OF THE DRAWINGS

FIG. 1 shows a schematic of produced water treatment.

FIG. 2A shows an RO desalination unit.

FIG. 2B shows a thermal desalination unit.

FIG. 3 shows a schematic of a desalination unit/process with optional carbon sequestration in accordance with an embodiment of the present invention.

FIG. 4 shows the titration curve of typical Permian Basin produced water.

FIG. 5 shows the carbonate system equilibrium as a function of pH.

### DETAILED DESCRIPTION

FIG. 1 shows a typical produced water treatment on site. Water from central processing facility (101) is fed into the PW treatment plant consisting of a flotation tank (103) to separate oil and grease, a mixing tank (105) for removal of suspended solids, and dissolved polymers and frac chemicals by coagulation and flocculation, followed by a walnut filter unit (107) prior to a membrane filter for desalination, typically a RO unit (109). The filtered and desalinated clean water is then fed into a storage tank for re-use or further treatment as need be. If the PW has high hardness content, lime softening (not shown) can be employed before desalination.

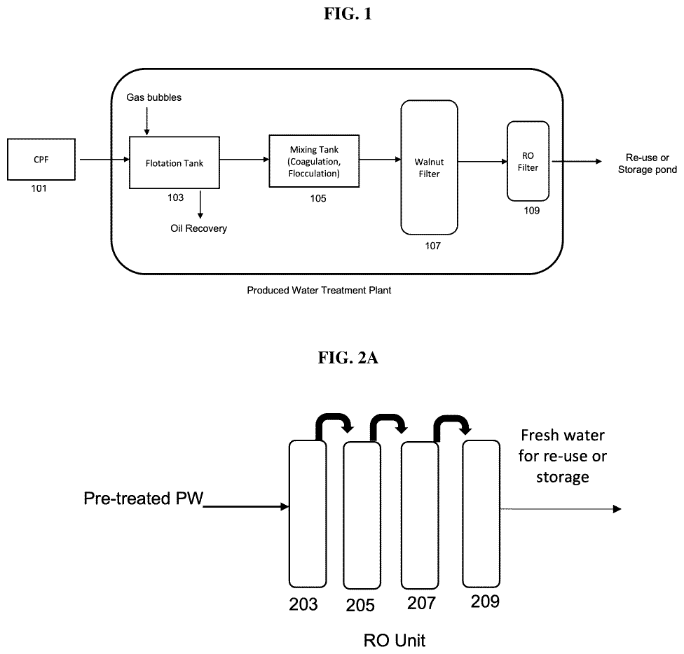

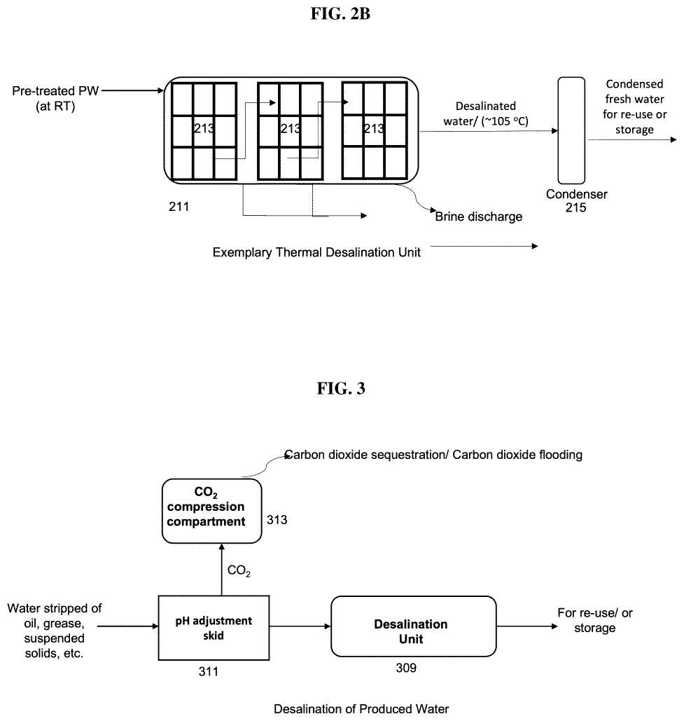

FIG. 2A details a typical membrane filter unit with a RO filter. Pre-treated produced water is fed into the RO system fitted with an antiscalant dosing system (203), a dichlorination unit (205), a semi-permeable filter (207) and a UV sterilizer (209). Fresh clean water is collected at the end of the filtration cycle. Other fittings to the RO system can be attached including carbon filters and/or water softeners that are not shown in the figure.

FIG. 2B shows an exemplary thermal desalination unit. Pre-treated produced water at room temperature is fed into a thermal distillation unit (211) containing boilers (213) at varying temperatures from low to high. Three boilers are shown in the figure as example, but there may be 1-15 boilers of varying volumes fitted to the thermal distillation units. Produced water is pass through the boilers, and desalinated water is fed into a condenser (215) where the resulting freshwater is cooled to room temperature and is re-used or sent to storage unit. Concentrated brine solution is ejected out of the boiler unit for discharge.

FIG. 3 shows a desalination unit proposed in the disclosure with an optional carbon sequestration unit (313). As can be seen, treated produced water is fed into a pH adjustment skid (311). If the produced water contains large amounts of carbonate or bicarbonate salts, carbon dioxide is released which is transferred to a carbon dioxide compression compartment (313) for carbon sequestration by carbon dioxide flooding of reservoir. The pH-adjusted water with a slightly acidic pH is then fed into a desalinator (309). The clean low pH desalinated water from the desalination unit is then passed to either polishing or a storage unit for re-use. The desalination unit (309) can be, for example, a RO filter or a thermal separation unit. The space requirement for a thermal unit is more, and is typically used in facilities with larger area dedicated for water purification methods and for PW with high salt.

In an oil and gas facility with a medium to high TDS produced water, a water desalination system as discussed in the present disclosure could be attached. The water typically has been at least through the oil-and-water separators at the CPF, then to a deoiler, flotation tank, and any other treatments needed before desalination. Such treatments can include any described herein or known in the art, except lime softening, which is omitted from the inventive methods. Operators can select suitable techniques given the degree of contamination of the original produced water, as well as the efficacy of the applied technology in reducing organics and solids.

A pre-desalination step using a pH adjustment skid is carried out wherein the resulting water is acidified to a pH of about 5-6, thus converting carbonate to CO₂, which can be removed. The de-carbonated produced water exhibits a lower Langelier Saturation Index and lower degree of saturation of calcium carbonate. This lower pH also forces most of the ammonia to remain in an aqueous state, during thermal desalination, thereby lowering the amount of ammonia carry-over into the distillate. In membrane desalination applications, the produced water may undergo additional pH adjustment prior to desalination to improve removal of soluble organic constituents and specific inorganic salts, if needed, to result in a high-quality pretreated water stream ready to enter the desalination unit. This can be referred to as “ready-water” herein.

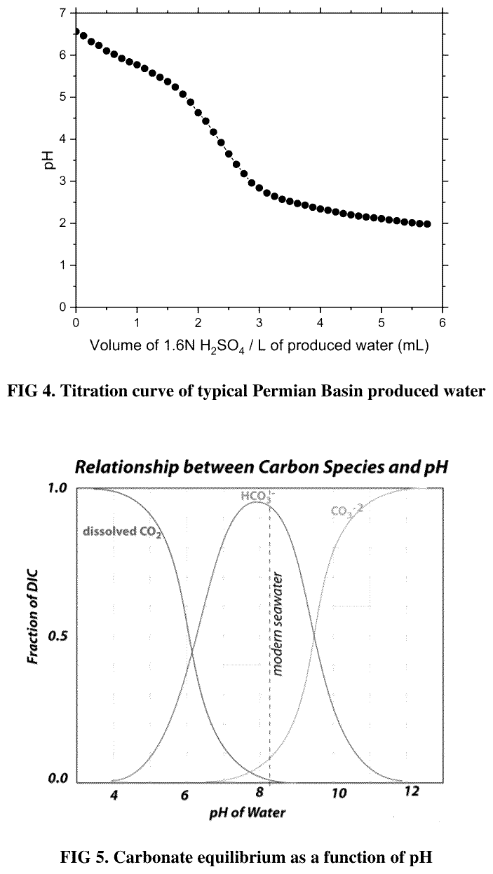

Recent laboratory testing to develop a titration curve for raw produced water from a Permian Basin formation provides a basis of understanding of pH adjustment of the complex chemistries of a typical produced water. FIG. 4 depicts the results of titrating raw produced water, collected from an Aris Water Solutions produced water recycling and disposal well site, using 1.6N sulfuric acid across the pH range from its ambient pH of pH 6.6 to approximately pH 2. This data can be used to determine the amount of acid required to achieve the desired pH for CO₂ removal recognizing the economic trade-offs between additional acid and the natural buffering capacity of the water enabled by the carbonate system.

From FIG. 5, depicting the known equilibrium relationship of the carbonate system (CO₂/HCO₃⁻/CO₃²⁻) as a function of pH, one can determine that at pH 5.5, approximately 80% of the carbonate species will be in the form of gaseous CO₂ and may be removed via air stripping. Referring to FIG. 4, one can conclude that approximately 1.3 mL of 1.6 N sulfuric acid would provide this shift in equilibrium to facilitate air stripping of the carbon dioxide.

The ready-water is then fed into either a thermal or a membrane desalinator. In this example, an RO system with a multimedia prefilter is used. TDS of the produced water would typically be measured before any water purification treatment, and then measured again before feeding produced water into the desalination unit and finally after desalination.

We anticipate that the medium to high TDS of the produced water in the field when fed into the desalination unit after the pH adjustment would produce water with 0 or very low (<1000) water. The predicted results of this application are shown below in Table 2.

TABLE 2
TDS of produced water (prophetic)

| | TDS at | | |
|---|---|---|---|
| | injection into | | |
| | water | | |
| | purification | TDS before | TDS after |
| Field | system | desalination | desalination |
| A | High | Medium to High | 0 (very low) |
| B | High | Medium to High | 0 (very low) |

Testing has confirmed successful decarbonation and desalination of high salinity PW. Table 3 provides results for a thermal desalination system and Table 4 for membrane desalination treatment.

TABLE 3
Thermal Desalination Pilot Water Quality Results

| | | Inlet | | Air Stripper | Post |
|---|---|---|---|---|---|
| | | Bicarbonate | | Outlet | Treated |
| Inlet PW | | Alkalinity | pH at Air | Bicarbonate | Distillate |
| TDS | Inlet | as CaCO₃ | Stripper | Alkalinity as | TDS |
| (mg/L) | pH | (mg/L) | Inlet | CaCO₃ (mg/L) | (mg/L) |
| 130,000 | 6.71 | 170 | 5.78 | 104 | 224 |
| 137,000 | 6.23 | 130 | 5.55 | 57.2 | 520 |
| 126,000 | 6.66 | 206 | 5.62 | 68.5 | 398 |
| 132,000 | 6.11 | 187 | 4.89 | 48.1 | 302 |
| 111,000 | 6.82 | 153 | 5.20 | 70.0 | 233 |
| 122,000 | 6.80 | 151 | 5.28 | 98.4 | 260 |
| 119,000 | 6.80 | 152 | 5.37 | 81.1 | 260 |

TABLE 4
Membrane Desalination Pilot Water Quality Results

| Inlet PW | | Inlet | | Air Stripper | Permeate |
|---|---|---|---|---|---|
| TDS | | Bicarbonate | pH at | Outlet | Con- |
| (Con- | | Alkalinity | Air | Bicarbonate | ductivity |
| ductivity | Inlet | as CaCO₃ | Stripper | Alkalinity as | (umho/ |
| (umho/cm) | pH | (mg/L) | Inlet | CaCO₃ (mg/L) | cm) |
| 171,000 | 6.64 | 107 | 5.11 | 34 | 380 |
| 161,800 | 6.71 | 110 | 5.00 | 28 | 335 |
| 169,800 | 6.68 | 112 | 5.11 | 33 | 345 |

The examples herein are intended to be illustrative only and do not limit the scope of the appended claims. Although the present disclosure and its advantages have been described in detail, it should be understood that various changes, substitutions and alterations can be made herein without departing from the scope of the disclosure as defined in the claims.

1. A method of desalinating produced water, the method comprising:
deoiling water produced from an oil or gas well;
removing suspended solids in the deoiled water;
acidifying the deoiled produced water to have a pH value between 5.0 and 6.0; and
desalinating the acidified water to produce desalinated water having 0-200,000 ppm total dissolved solids (TDS).

2. The method of claim 1, further comprising:
stripping CO₂ from the acidified water.

3. The method of claim 2, wherein the stripped CO₂ is fed into a compression compartment.

4. The method of claim 1, further comprising:
polishing the desalinated water.

5. The method of claim 1, wherein the method is performed without using lime softening.

6. The method of claim 1, wherein the deoiling step comprises stripping at least one of oil and grease from the well-produced water.

7. The method of claim 1, wherein the acidifying step comprises using at least one of sulfuric acid, phosphoric acid, hydrochloric acid, and nitric acid.

8. The method of claim 1, further comprising:
determining an amount of acid required for the acidifying step.

9. The method of claim 1, wherein the acidifying step comprises removal of at least one of soluble organic constituents and inorganic salts.

10. The method of claim 1, wherein the desalinating step comprises using at least one of a membrane desalinator and a thermal desalinator.

11. A water desalination system, comprising:
a deoiler unit arranged to receive water produced from an oil or gas well;
a pH adjustment skid unit arranged to receive deoiled water from the deoiler unit and produce pH-adjusted water having a pH value between 5.0 and 6.0; and
a desalinator unit arranged to receive the pH-adjusted water from the pH adjustment skid and produce desalinated water having 0-200,000 ppm total dissolved solids (TDS).

12. The water desalination system of claim 11, further comprising:
a carbon dioxide compression compartment arranged to receive CO₂ gas from the pH adjustment skid.

13. The water desalination system of claim 11, further comprising:
a polishing unit arranged to receive desalinated water from the desalinator unit.

14. The water desalination system of claim 11, wherein the desalinator unit comprises membrane filter.

15. The water desalination system of claim 14, wherein the membrane filter comprises a reverse osmosis filter.

16. The water desalination system of claim 11, wherein the desalinator unit comprises a thermal desalination unit.

17. The water desalination system of claim 11, wherein the water desalination system does not comprise a lime softener unit.

18. The water desalination system of claim 11, wherein the pH adjustment skid is arranged to apply at least one of sulfuric acid, phosphoric acid, hydrochloric acid, and nitric acid to the received deoiled water.

19. The water desalination system of claim 11, further comprising:
a storage unit arranged to receive and store the desalinated water for subsequent beneficial reuse.

20. The water desalination system of claim 11, wherein the pH adjustment skid unit is configurable to produce the pH-adjusted water based on properties of the well-produced water.
